(19) United States
(12) Patent Application Publication
(10) Pub. No.: US 2007/0235481 A1
(43) Pub. Date: Oct. 11, 2007

(54) Low profile baton scabbard

(76) Inventor: Kevin L. Parsons, Appleton, WI (US)

Correspondence Address: Welsh & Katz, Ltd.;Jon P. Christensen, 22nd Floor, 120 South Riverside Plaza, Chicago, IL, 60606, US

(21) Appl. No.: 11/240,412

(22) Filed: Sep. 30, 2005

(51) Int. Cl. A01K 97/04; A45F 5/00; A01K 97/06

(52) U.S. Cl. 224/197; 224/914; 224/251

(57) ABSTRACT

A scabbard for a police baton is provided. The scabbard includes a receiver for the police baton, said receiver having a tubular body that is substantially continuous in an annular and axial direction, a mounting flange disposed on an outer surface of the tubular body proximate a first end of the tubular body, said mounting flange defined by an unobstructed planar mounting surface substantially surrounding a center aperture, said planar mounting surface being substantially tangent to an outer surface of the tubular body and a closed-loop belt clip rotatably attached to the mounting surface.

### FIELD OF THE INVENTION

The field of the invention relates to police batons and more particularly to scabbards used to carry batons.

### BACKGROUND OF THE INVENTION

Police and security personnel are often required to carry weapons of intermediate force such as nightsticks or batons. Batons are available in a variety of sizes, usually consisting of three telescoping sections. In the retracted position, an expandable baton is only approximately one-third of its extended length.

In order for a baton to be of maximum utility to the officer or other baton user, it should be able to be carried by the officer at all times while on duty, and without interfering with the mobility of the officer when it is not needed. On the other hand, the baton must be able to be quickly deployed by the officer whenever needed.

When not in use, batons are usually carried in a scabbard that may be attached to a waist belt of the officer. In general, a baton scabbard can be used to enable the efficient use and transport of a baton. The scabbard should allow for a wide range of deployment or withdrawal directions that may be required when in pursuit or subduing a subject. The scabbard should secure the baton to the officer during the officer's daily activities, such as when the officer is pursuing a subject and may be required to run, jump, climb over walls or fences or move quickly up or down stairs. The scabbard should secure the baton in a manner which allows for full body movement by the officer. It should allow the officer to comfortably carry the baton throughout the day including when the officer is standing or sitting.

U.S. Pat. No. 6,889,878 to Parsons, assigned to the assignee of the present invention, is an example of a baton scabbard that substantially meets the needs of police officers. While Parsons is effective, it is also relatively complex to construct. Because of the importance of the safety of police officers a need exists for a baton scabbard that has the functionality of Parsons, but is less complex and easier to manufacture.

### BRIEF DESCRIPTION OF THE DRAWINGS

FIG. 1 is a front perspective view of a baton scabbard in accordance with an illustrated embodiment of the invention;

FIG. 2 is an exploded view of the belt clip assembly of FIG. 1;

FIG. 3 is a front, perspective view of the closed-loop belt clip of FIG. 1;

FIG. 4 is a front view of the baton scabbard of FIG. 1 with the belt clip assembly being show rotated into alternate positions;

FIG. 5 is a side view of the scabbard of FIG. 1 showing a belt of a user in phantom;

FIG. 6 is a side cut-away view of the scabbard of FIG. 5;

FIG. 7 is a top, perspective view of the scabbard of FIG. 1;

FIG. 8 is a side view of the scabbard of FIG. 1;

FIG. 9 is a rear, perspective view of the scabbard receiver of FIG. 1; and

FIG. 10 are views of opposing, mating structures of FIG. 1 including a back view of the belt clip assembly, shown on the left and a back view of the receiver shown on the right.

### SUMMARY

A scabbard for a police baton is provided. The scabbard includes a receiver for the police baton, said receiver having a tubular body that is substantially continuous in an annular and axial direction, a mounting flange disposed on an outer surface of the tubular body proximate a first end of the tubular body, said mounting flange defined by an unobstructed planar mounting surface substantially surrounding a center aperture, said planar mounting surface being substantially tangent to an outer surface of the tubular body and a closed-loop belt clip rotatably attached to the mounting surface.

### DETAILED DESCRIPTION OF AN ILLUSTRATED EMBODIMENT

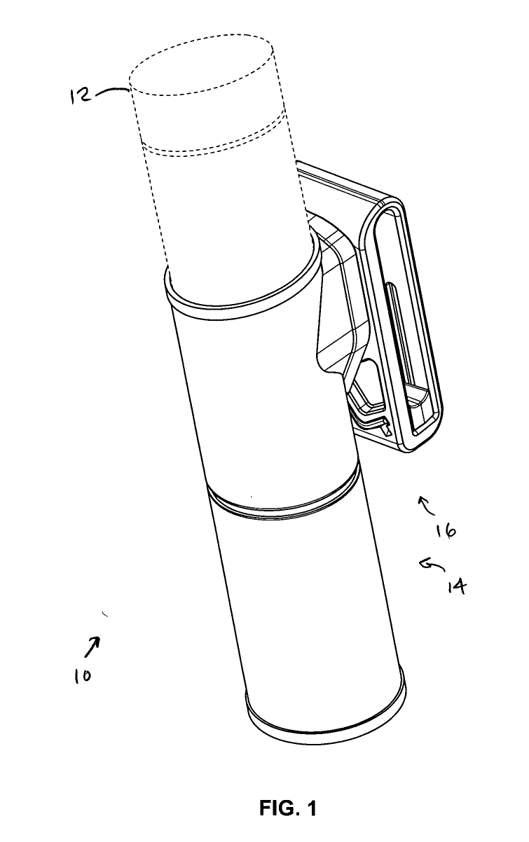

FIG. 1 is a front perspective view of a low-profile baton scabbard 10 shown generally in accordance with an illustrated embodiment of the invention. Also shown in FIG. 1 is a baton 12 (shown in phantom) disposed within the scabbard 10.

The scabbard 10 includes a baton receiver 14 and a belt clip assembly 16. The receiver 14 is constructed of a relatively thin, lightweight tubular body 18 that is substantially continuous in the axial and annular directions. The tubular body 18 may be fabricated of any appropriate light weight material (e.g., plastic, delrin, acetel, polycarbonate, etc.).

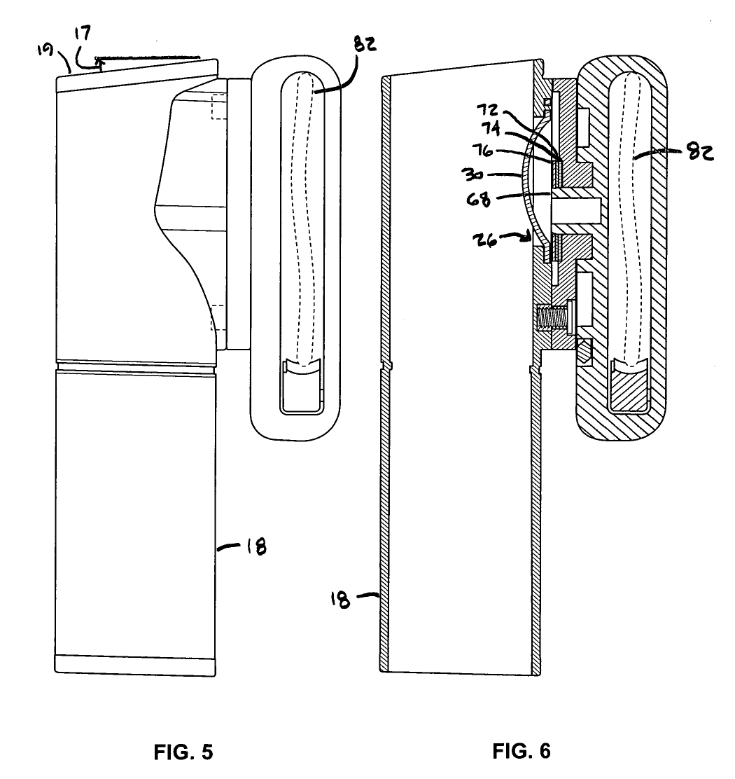

The upper portion of the tubular body 18 (adjacent the belt clip assembly 16) may be provided with a slanted top 19 (FIG. 5). The slanted top 19 may be slanted downward on an outside of the receiver 14 from horizontal by some appropriate angle 17 (e.g., eight degrees) to facilitate easy insertion of the baton 12 into the scabbard 10.

The tubular body 18 may also include a baton stop tab 36 (FIG. 9) disposed along a lower, second end of the tubular body 18. The baton stop tab 36 extends inwardly from the tubular body 18 towards a center of the annulus of the tubular body 18. The baton stop tab 36 is of such size as to leave a distance 38 that is sufficient to allow a distal end of the baton 12 to pass through, but insufficient to allow a second end (handle) of the baton 12 to pass through.

The use of the stop tab 36 allows the scabbard 10 to receive the baton 12 in either the extended or retracted state. In the retracted state, the baton 12 may be received within the scabbard 10 as shown in FIG. 1. In the extended state, a first and second sections of the baton 12 may extend past the stop tab 36 with only the upper handle portion contained within the tubular body 18.

The receiver 14 includes a mounting flange 20 (FIG. 9). Under one preferred embodiment, the mounting flange is an extension of the wall of the tubular body 20 that forms a relatively flat surface. The relatively flat surface is substantially tangent to the tubular body 18.

The mounting flange 20 may be formed as an integral part of the tubular body 18 using some appropriate process (e.g., injection molding, ultrasonic welding, etc.). Under another preferred embodiment, the mounting flange 20 may be formed separately and attached to the tubular body 18 by attachment devices (e.g., screws, rivets, etc.).

Disposed on an outside surface of the mounting flange 20 is an unobstructed peripheral mounting surface (flange surface) 22 for the belt clip assembly 16. The peripheral mounting surface is unobstructed because it doesn't have sides extending upwards from the outside edge of the mounting surface 22 that would otherwise make the mounting surface wider than necessary. The peripheral mounting surface 22 lies within a single plane that is substantially tangent to an outer surface of the tubular body 18. The peripheral surface 22 may form a continuous surface around the periphery of the flange 20, as shown in FIG. 9, or may be discontinuous in some areas around the periphery.

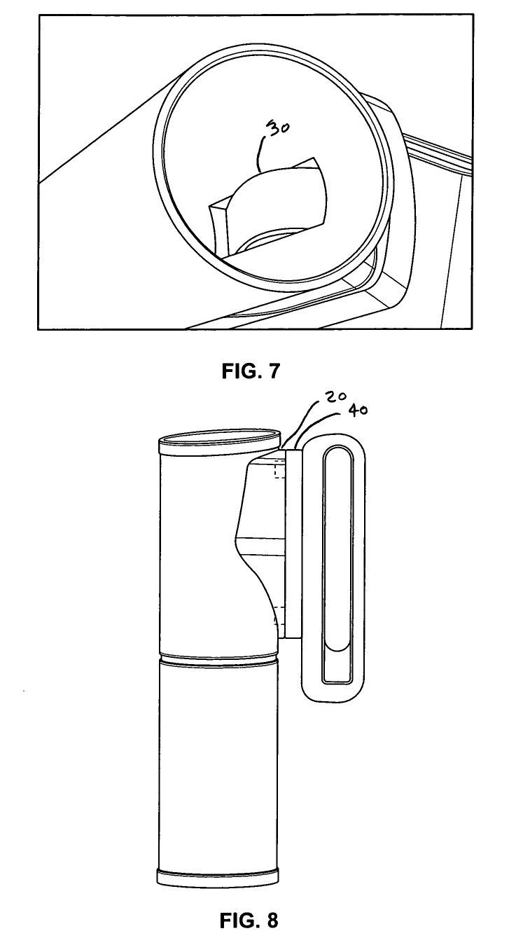

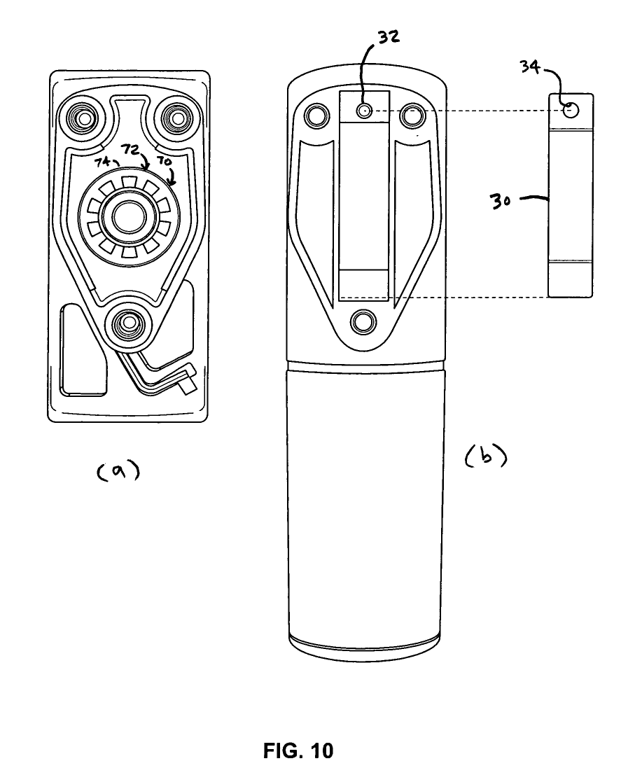

Located within the peripheral mounting surface 22 may be one or more apertures 24, 26, 28. The center aperture 26 may extend between the plane of the peripheral mounting surface 22 and the interior of the tubular body 18, as may be more clearly seen in FIGS. 6 and 10.

Disposed within the center aperture 26 may be a leaf spring 30. The spring 30 may have a continuously curved center portion (FIGS. 6 and 7) that engages and secures the baton 12 within the tubular body 18 of the scabbard 10. The continuously curved center portion has been found to allow much easier insertion and removal of the baton from scabbard 10. A post 32 on the flange 20 may engage an aperture 34 within the leaf spring 30 to hold the spring 30 in the proper, operational position.

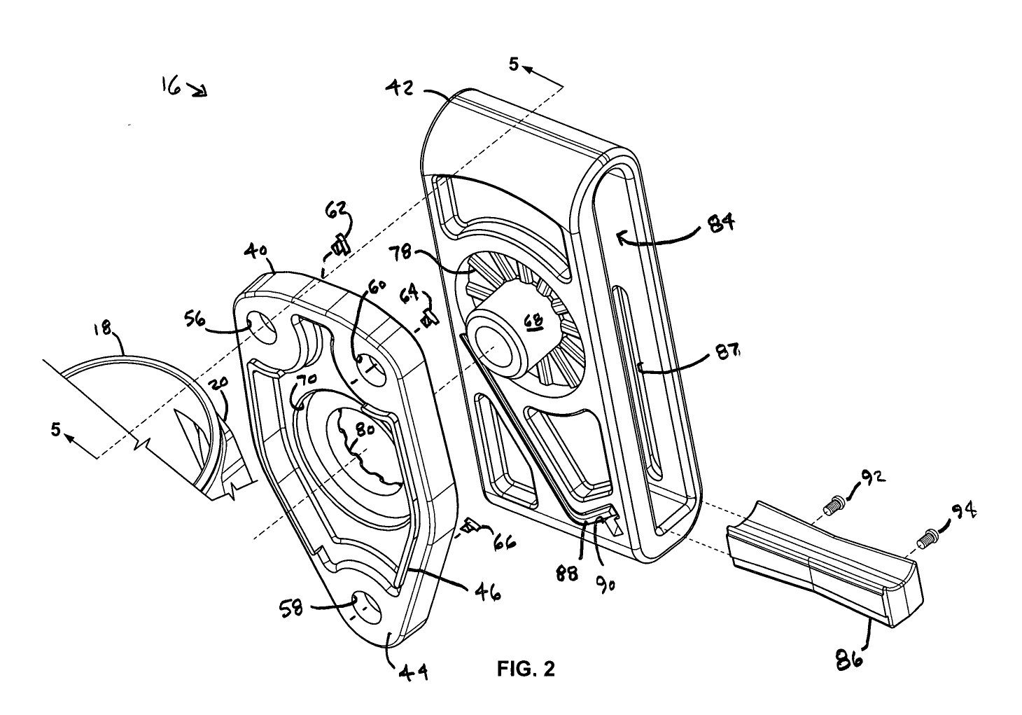

FIG. 2 shows an exploded view of the belt clip assembly 16. The belt clip assembly 16 may include a belt clip mounting plate 40 and a closed-loop belt clip 42. The belt clip mounting plate 40 may also include a peripheral mounting surface (clip surface) 44 that is complementary to the peripheral mounting surface 22 of the flange 20. Complementary in this case means that the clip mounting surface 44 has substantially the same shape and lies in the same plane as the flange surface 22 during use.

Disposed along an inside edge of clip surface 44 is a projecting ridge 46. The projecting ridge 46 functions as an alignment mechanism for the mechanical junction between the receiver 14 to belt clip assembly 16.

Attachment of the belt clip assembly 16 to the flange 20 may be accomplished via the aid of the ridges 46 and an attachment mechanism. In one preferred embodiment, a set of metal bosses 48, 50, 52 (FIG. 9), each with a female thread 54, may be ultrasonically welded into apertures disposed within the flange surface 22. A complementary set of apertures 54, 58, 60 allow the belt clip mounting plate 40 to be secured to the flange 20 via screws 62, 64, 66 that engage the bosses 48, 50, 52 through the belt clip mounting plate 40.

The closed-loop belt clip 42 may be secured to the belt clip mounting plate 40 via a post 68 that extends through an aperture 70 in the belt clip mounting plate 40. Once the post 68 has been inserted through the aperture 70 a suitable circular push-on external retaining ring 76 (e.g., available from Truarc Manufacturing Co.) may be disposed on a protruding end of the post 68. A set of wave washers 72, 74 between the retaining ring 76 and belt clip mounting plate 40 may urge the closed-loop belt clip 42 and belt clip retaining plate 40 into contact.

Disposed between the belt clip mounting plate 40 and closed-loop belt clip 42 are a series of respective ridges 76 and slots 78 disposed on respective sides of the belt clip mounting plate 40 and closed-loop belt clip 42 and extending radially outwards from the post 68. The ridges 78 and slots 80 are complementary in that the ridges 78 and sized to fit into the slots 80 to retain a selected position.

The receiver 14 is rotatable with respect to the belt clip assembly 16. To select a different orientation between the receiver 14 and belt clip assembly 16, user may simply install the scabbard 10 on his belt 82, grasp and rotate the receiver 14 to a desired position. As the user rotates the receiver 14, the interaction of the tapered edges of the ridges 78 and slots 80 cause the wave washers 72, 74 to compress thereby releasing the receiver 14 to rotate to a new position where the ridges 78 may engage new slots 80.

The closed-loop belt clip 42, as shown in FIGS. 1, 2, 3, 5, 6 and 8 has a belt space 84 that completely encircles the belt 82. Disposed within the belt space 84 is an adjustable spacer 86. A pair of slots 87 extend along a wall of the closed-loop belt clip 42 in a direction across a width of the belt (i.e., transverse to a direction of the belt 84). A pair of screws 92, 94 may engage the spacer 86 through the slots 87. By loosening the screws 92, 94, the spacer 86 can be moved vertically to accommodate any width belt worn by a user.

Disposed between the belt clip plate 40 and the closed-loop clip 42 may be an allen wrench 88 held within an allen wrench slot 90 (FIGS. 2 and 3). In order to facilitate easy adjustment of the spacer 86 or assembly or disassembly (and replacement of parts), screws 62, 64, 66, 92, 94 may all be allen screws of a single size that are removable through use of the wrench 88.

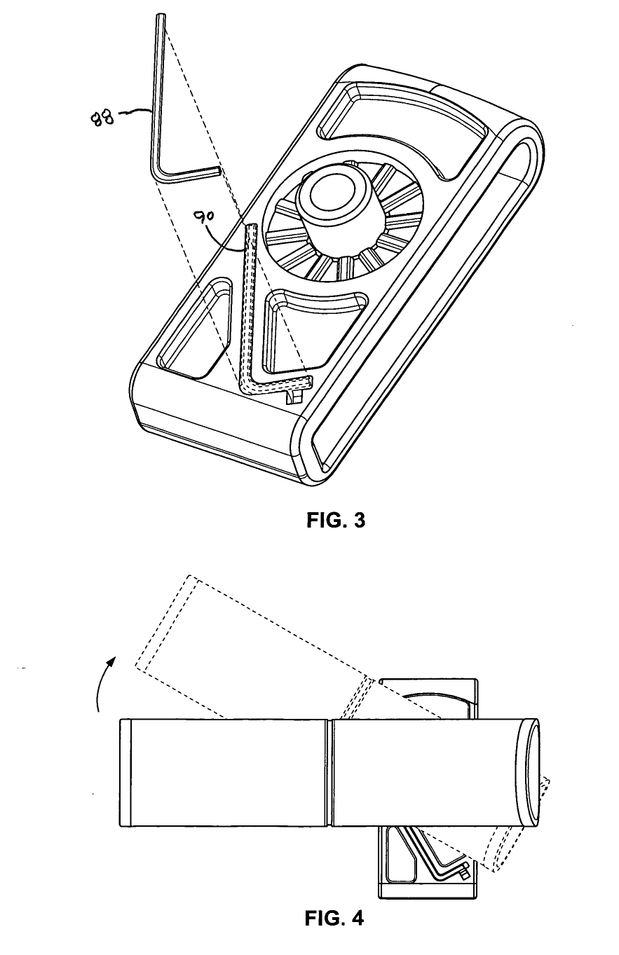

The allen wrench 88 may be inaccessible when the scabbard 10 is in the position shown in FIG. 1. Not only is the alien wrench 88 inaccessible in the position shown in FIG. 1, but the allen wrench 88 cannot fall or and be lost while the scabbard 10 is in the position shown in FIG. 1. Access to the allen wrench 88 and removal from the scabbard 10 may be accomplished by rotating the receiver 14 to the position shown by the solid lines in FIG. 4.

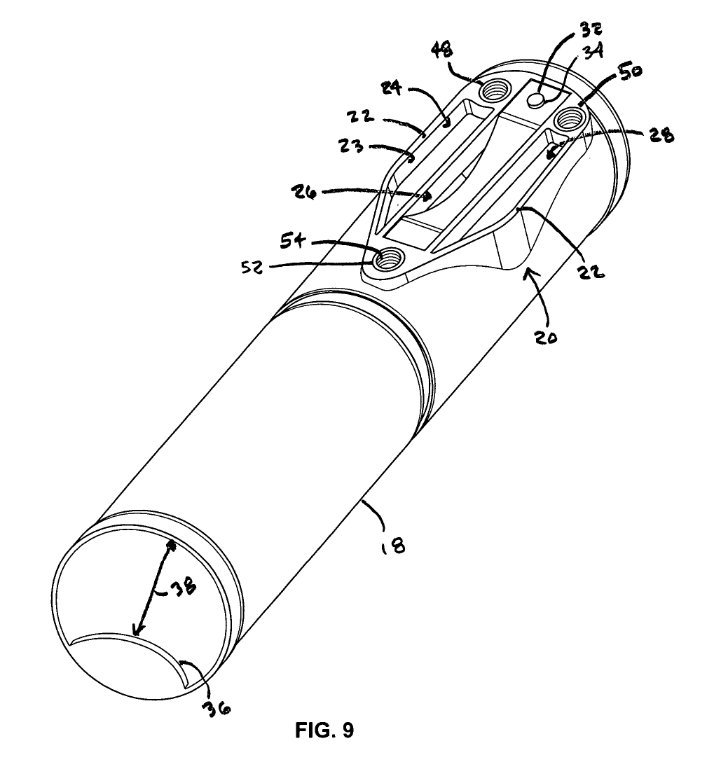

The belt clip assembly 16 may be assembled to the receiver 14 by bringing the flange surface 22 into proximate contact with the clip surface 44 (FIG. 8). Final alignment of the flange surface 22 to the clip surface 44 occurs when the ridge 46 enters the apertures 24, 28 and engages the inner edge of the flange peripheral mounting surface 22.

When the flange surface 22 is aligned with the clip surface 44 the apertures 56, 58, 60 are complementary to the bosses 48, 50, 52 in that the apertures 56, 58, 60 lie directly above the threaded bosses 48, 50, 52. The belt clip assembly 16 may then be secured to the receiver 14 via screws 62, 64, 66.

Once the belt clip assembly 16 has been secured to the receiver 14, the ridges 46 contact and slightly deform upon contacting the inner edge of the flange surface 22, thereby establishing an interference fit between the flange 20 and belt clip assembly 16. The interference fit prevents lateral movement between the belt clip assembly 16 and receiver 14. In addition, the relatively large surface area of the flange surface 22 and complementary clip surface 44 distributes the direct and shock loading of use over a relatively large surface area.

The ridge 46 eliminates any lateral loading on the screws 62, 64, 66. The screws 62, 64, 66 are therefore subject exclusively to axial loading. The relatively large surface area of the flange surface 22 and clip surface 44 reduces the force per unit area (lbs/in²) to a relatively low level.

The distribution of forces over a relatively large area allows the mounting flange 22 to be reduced in size and to occupy only a portion of the length of the receiver 14. As shown in the figures, the mounting flange 22 occupies an area of less than one-half of the length of the receiver 14.

A specific embodiment of a baton scabbard has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A scabbard for a police baton comprising:
a receiver for a police baton, said receiver having a tubular body that is substantially continuous in an annular and axial direction;
a mounting flange disposed on an outer surface of the tubular body proximate a first end of the tubular body, said mounting flange defined by an unobstructed planar mounting surface substantially surrounding a center aperture, said planar mounting surface being substantially tangent to an outer surface of the tubular body; and
a closed-loop belt clip rotatably attached to the mounting surface.

2. The scabbard as in claim 1 further comprises a belt clip mounting plate disposed between the mounting flange and closed loop belt clip, said belt clip mount plate having a peripheral mounting surface that is complementary to the unobstructed mounting surface.

3. The scabbard as in claim 2 wherein the peripheral mounting surface of the belt clip assembly further comprises a ridge that engages a periphery of the aperture.

4. The scabbard as in claim 3 further comprising a plurality of threaded bosses disposed within the unobstructed mounting surface.

5. The scabbard as in claim 4 further comprising a plurality of screws that engage the threaded bosses through a corresponding plurality of apertures in the belt clip mounting plate of the belt clip assembly to detachably secure the belt clip mounting plate to the mounting flange.

6. The scabbard as in claim 5 wherein the closed-loop belt clip further comprises a post extending through a aperture in the belt clip mounting plate, said closed-loop belt clip being adapted to rotate relative to the receiver about the post.

7. The scabbard as in claim 6 further comprising a spring-loaded fastener adapted to engage a distal end of the post on a side of the belt clip mounting plate that is opposite the closed-loop belt clip.

8. The scabbard as in claim 7 further a wave washer disposed on the post between the spring-loaded fastener and the belt clip mounting plate.

9. The scabbard as in claim 8 further a plurality of ridges and complementary slots disposed on opposing sides of the belt clip mounting plate and closed-loop belt clip extending radially outwards from the post and adapted to retard rotation of the closed-loop belt clip relative to the receiver.

10. The scabbard as in claim 1 wherein the closed-loop belt clip further comprises an adjustable spacer within a belt space of the closed-loop belt clip that is adapted to adjust a belt width dimension of the belt space.

11. The scabbard as in claim 10 further comprising a slot disposed in a wall of the closed-loop belt clip extending along the belt width dimension of the closed-loop belt clip.

12. The scabbard as in claim 11 further comprising a locking mechanism extending through the slot and adapted to lock the spacer in a user-selectable belt width dimension.

13. The scabbard as in claim 2 wherein said center aperture further comprises a leaf spring with a continuously curved center portion where the center portion of the leaf spring extends through the tubular body to engage the police baton on a first side of the leaf spring and first and second ends of a second side of the leaf spring engaging a portion of the belt clip mounting plate.

14. The scabbard as in claim 13 further comprising an alignment post adjacent the center aperture adapted to align the leaf spring within the center aperture.

15. A scabbard for a police baton, such scabbard comprising:
a receiver for a police baton, said receiver having first and second ends and a tubular body with a relatively thin body wall that is substantially continuous in an annular and axial direction;
a baton stop tab disposed on an inner surface of the second end of the tubular body and extending inwardly towards a center of the annulus of the tubular body, said baton stop tab having an extension length that allows a first end of the baton to pass through the second end of the tubular body but not a second end of the baton;
an attachment flange disposed on an outer surface of the tubular body proximate the first end of the receiver, said attachment flange having a substantially planar attachment surface tangent to the outer surface of the tubular body and extending over a portion and only over a portion of a length of the tubular body;
a closed-loop belt clip rotatably coupled to the attachment flange.

16. The scabbard as in claim 1 wherein the attachment flange further comprises a flat peripheral mounting surface surrounding a center aperture, said flat peripheral mounting surface being disposed in a single plane tangent to an outer surface of the tubular body.

17. The scabbard as in claim 16 further comprising a belt clip mounting plate detachably mounted to the flange with a complementary flat peripheral mounting surface on the belt clip mounting plate that is complementary to the flat peripheral mounting surface of the flange.

18. The scabbard as in claim 17 wherein said center aperture further comprises a leaf spring with a continuously curved center portion where the center portion of the leaf spring extends through the tubular body to engage the police baton on a first side of the leaf spring and first and second ends of a second side of the leaf spring engaging a portion of the belt clip mounting plate.

19. The scabbard as in claim 18 further comprising an alignment post adjacent the center aperture adapted to align the leaf spring within the center aperture.

20. The scabbard as in claim 17 wherein
the complementary peripheral mounting surface further comprises a rib disposed on the belt clip mounting plate along an interior edge of the complementary peripheral mounting surface that is adapted to engage an interior edge of the peripheral mounting surface of the flange, said rib being adapted to align the belt clip mounting plate with the flange.

21. The scabbard as in claim 20 wherein
the peripheral mounting surface of the flange further comprises a plurality of bosses disposed in the peripheral mounting surface of the flange, each boss of the plurality of bosses including a centrally located female thread oriented perpendicular to the peripheral mounting surface of the flange.

22. The scabbard as in claim 21 wherein the complementary peripheral mounting surface further comprises a plurality of apertures where at least some apertures of the plurality of apertures are aligned with at least some bosses of the plurality of bosses.

23. The scabbard as in claim 22 further comprising a plurality of screws with male threads passing through the at least some apertures to engage at least some bosses of the plurality of bosses.

24. The scabbard as in claim 22 wherein the closed-loop belt clip further comprises a post extending through a aperture in the belt clip mounting plate, said closed-loop belt clip being adapted to rotate relative to the receiver about the post.

25. The scabbard as in claim 24 further comprising a spring-loaded fastener adapted to engage a distal end of the post on a side of the belt clip mounting plate that is opposite the closed-loop belt clip.

26. The scabbard as in claim 25 further a wave washer disposed on the post between the spring-loaded fastener and the belt clip mounting plate.

27. The scabbard as in claim 26 further a plurality of ridges and complementary slots disposed on opposing sides of the belt clip mounting plate and closed-loop belt clip extending radially outwards from the post and adapted to retard rotation of the closed-loop belt clip relative to the receiver.

28. The scabbard as in claim 15 wherein the closed-loop be It clip further comprises an adjustable spacer within a belt space of the closed-loop belt clip that is adapted to adjust a belt width dimension of the belt space.

29. The scabbard as in claim 28 further comprising a slot disposed in a wall of the closed-loop belt clip extending along the belt width dimension of the closed-loop belt clip.

30. The scabbard for a police baton as in claim 29 further comprising a locking mechanism extending through the slot and adapted to lock the spacer in a user-selectable belt width dimension.
